(19) United States
(12) Patent Application Publication
(10) Pub. No.: US 2006/0220854 A1
(43) Pub. Date: Oct. 5, 2006

(54) Switch for pre-listening the alarm bell of an alarm clock

(76) Inventor: Ching Hung Han, Kaohsiung Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/443,190

(22) Filed: May 31, 2006

(30) Foreign Application Priority Data
Oct. 7, 2004 (TW) 093215913

(51) Int. Cl. G08B 13/14

(52) U.S. Cl. 340/571; 340/384.1

(57) ABSTRACT

The present invention relates to a kind of switch for pre-listening the alarm bells of an alarm clock, wherein the said switch comprising spacer and control switch, and thereat the control switch is coupled at one end of the said spacer and extensible installed on the packing box and, primarily, the said spacer is inserted into the battery compartment of alarm clock at a position located in-between the electrode and the battery so as to separate the electrode from the battery, and hence cut off the power supplied to the said battery inside the battery compartment, and instead, the power supplied to battery is controlled by the said control switch installed at one end of the said spacer in such a way that it is allowable for someone to pre-listen the alarm bells as well as be realizable operating status of such alarm clock while pressing on the control switch on the packing box directly.

### BACKGROUND OF THE INVENTION

1. Field of the Invention

The present invention relates to a kind of switch for pre-listening the alarm bells of an alarm clock, particularly to a kind of switch allowable for someone to pre-listen the alarm bells as well as be realizable operating status of such alarm clock while pressing on the control switch on the packing box directly.

2. The Prior Arts

Because the alarm bell mechanism generally is installed inside the alarm clock housing, therefore it is necessary to install a switch to activate the bell so as to allow the consumer to find out what quality or tone this bell is? Particularly, the various alarm clocks on the markets usually have different alarm bells, and more over, due to theses alarm clocks displayed in the stores are all well-wrapped in the external packing, therefore it is difficult for the consumers to find out what quality or tones these bells are? And under this circumstance, the only way to evaluate the quality or tone of these alarm clocks is to ask the salesclerk to open the packing, install batteries and make a proper setting as well, which is a problem due to it is not only very inconvenient for consumers but also wasting lots of time in testing and listening the different tones. Thus, there is a necessity to develop a kind of switch capable in pre-listening the alarm bell, which is not only be able to achieve an objective in finding out the alarm bell in advance and even more capable in examining the operation status in the meantime as well.

### SUMMARY OF THE INVENTION

The present invention relates to a kind of switch for pre-listening the alarm bells of an alarm clock, wherein it is mainly comprising the spacer and the control switch, and thereat the control switch is coupled at one end of the said spacer and extensible installed on the packing box and, primarily, the said spacer is available inserted into the battery compartment of alarm clock at a position located in-between the electrode and the battery so as to separate the electrode from the battery, and hence cut off the power supplied to the said battery inside the battery compartment, and instead, the power supplied to battery is controlled by the said control switch installed at one end of the said spacer, and in this way while pressing on the control switch to activate the alarm clock, the disconnected power for the battery will be supplied again to electrode positioned at the battery compartment firstly via the control switch according to the said spacer, and then energizing the clock movement appropriately to go off the alarm bell directly. Therefore, it is allowable for a purchaser to pre-listen the alarm bells as well as realize the operating status of such alarm clock while she/he is simply pressing on the control switch on the packing box, so we might say that it is truly a very easy and convenient way to operate without any necessity to open its packing at all.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of the switch in accordance with the present invention;

FIG. 2 is a schematic stereoscopic assembly view of the switch in accordance with the present invention;

FIG. 3 is a stereoscopic assembly view of the switch in accordance with the present invention;

FIG. 4 is an assembly view of the switch in accordance with the present invention;

FIG. 5 is an accomplished assembly view of the switch in accordance with the present invention;

FIG. 6 is a sectional assembly view of the switch in accordance with the present invention;

FIG. 7 is an operational view of the switch in accordance with the present invention;

FIG. 8 is a sectional view of the switch in accordance with the present invention;

FIG. 9 is a schematic view showing the activation status of the switch in accordance with the present invention;

FIG. 10 is a schematic view showing the current direction of the switch in accordance with the present invention

FIG. 11 is a sectional view of one preferred embodiment according to the present invention; and

FIG. 12 is an accomplished view of another kind of preferred embodiment according to the present invention.

### DETAILED DESCRIPTION OF THE PREFERRED EMBODIMENT

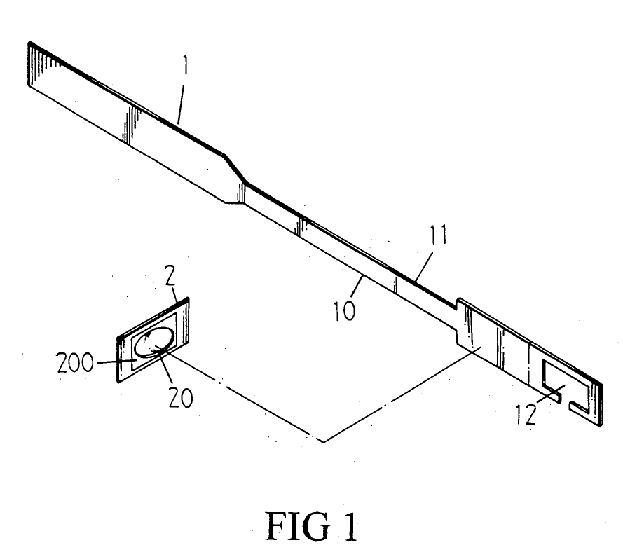

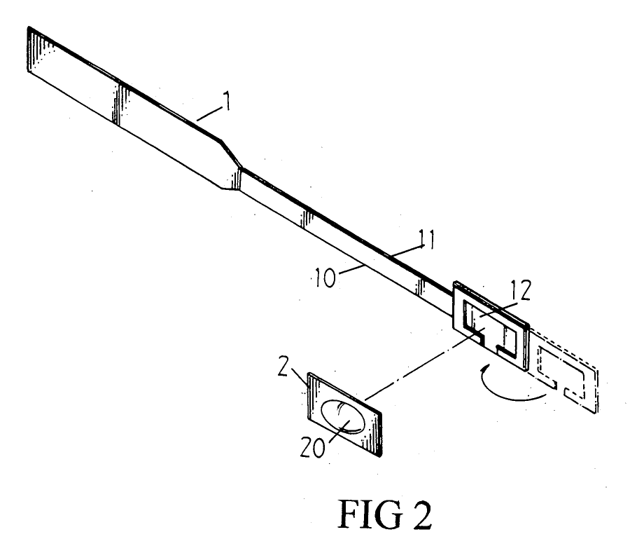

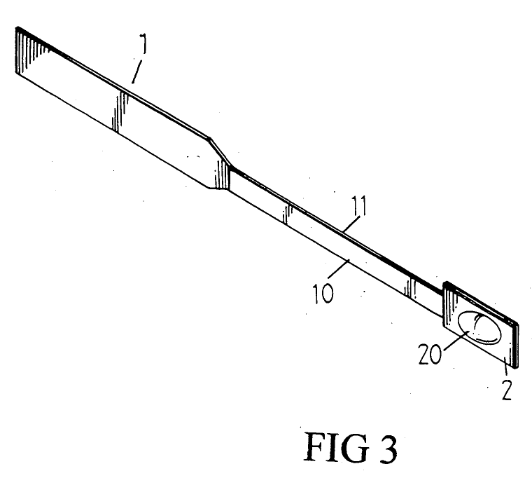

With reference to FIG. 1, the switch according to the present invention comprises the spacer 1 and control switch 2, wherein the spacer 1 is constructed as a lamella structure with two electricity-conductive surfaces 10 and 11 located at each side respectively, and there is a slot 12 positioned at the front end, whereat the said slot 12 has been folded partially (as shown in FIG. 2) so as to make one electricity-conductive surface 10 located in one side being attached to another electricity-conductive surface 11 located in other side, and hence make these two electricity-conductive surfaces 10 and 11 position in the same side and, in addition, the said two electricity-conductive surfaces 10 and 11 will be in conjunction again with the control switch 2; where a press embossment 20 is constructed at the center portion of said control switch 2 having an electricity-conductive surface 200, and in this way, it is applicable to accomplish the primary structure of said switch by controlling the operation method (in either contacting or detaching) for these two electricity-conductive surfaces 10 and 11 positioned at the same side while pressing said press embossment 20 accordingly (as shown in FIG. 3).

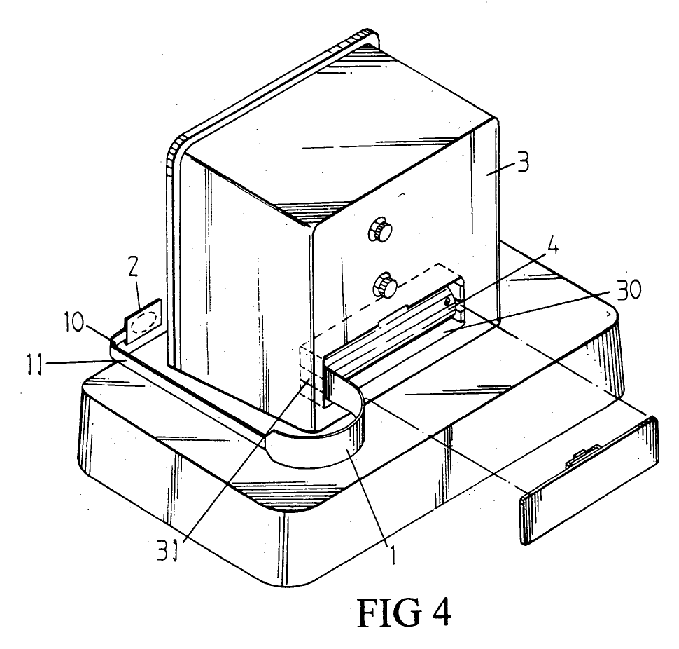

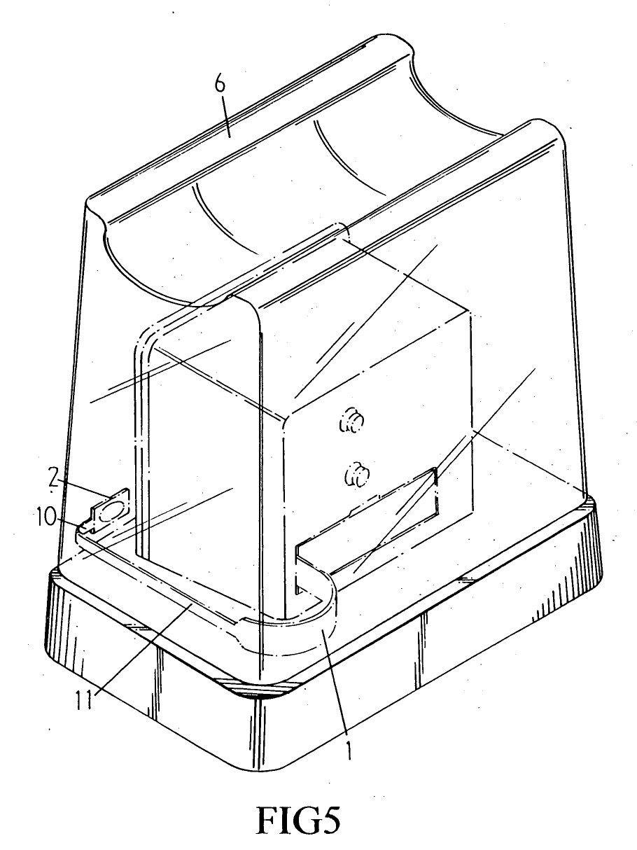

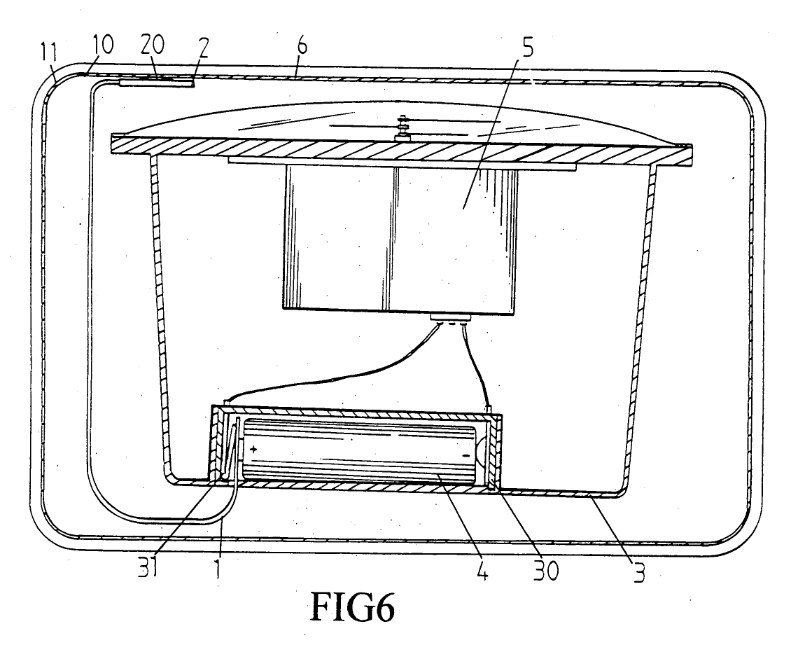

With reference to FIG. 4, primarily, the said spacer l is inserted into the battery compartment 30 of an alarm clock 3 at a position located in-between the electrode 31 and the battery 4 so as to separate the electrode 31 from the battery 4, and hence cut off the power supplied to the said battery 4 inside the battery compartment 30, and instead, the control switch 3 in conjunction at the other end is attached to internal side of said pacing box 6, where the primary structure for said switch is accomplished if the packing box 6 is being covered and coupled all together (as shown in FIGS. 5 and 6).

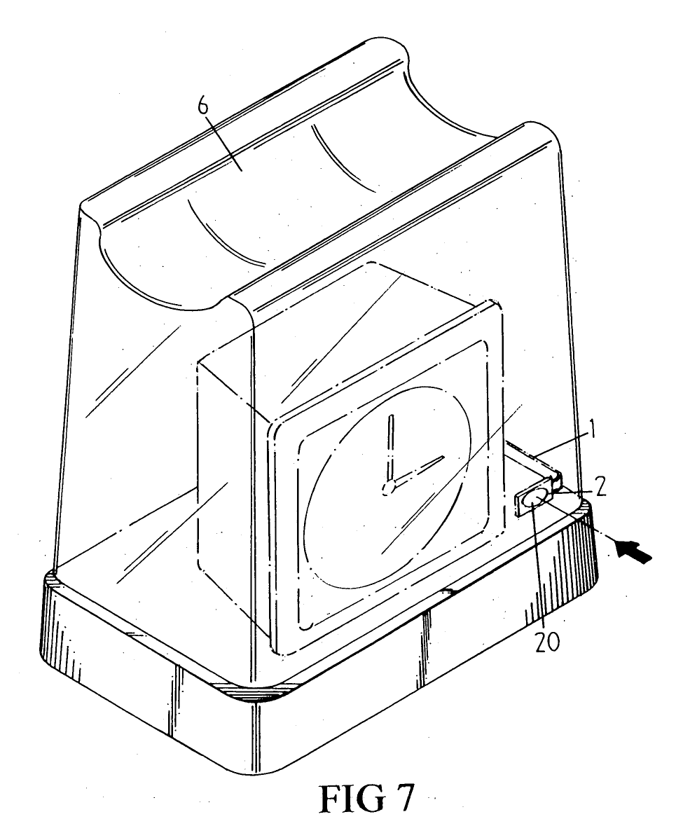

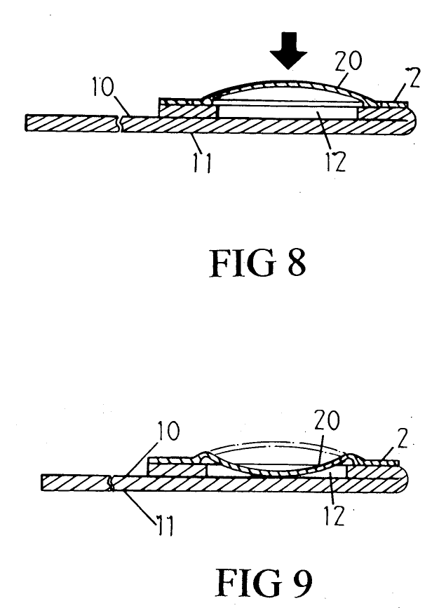

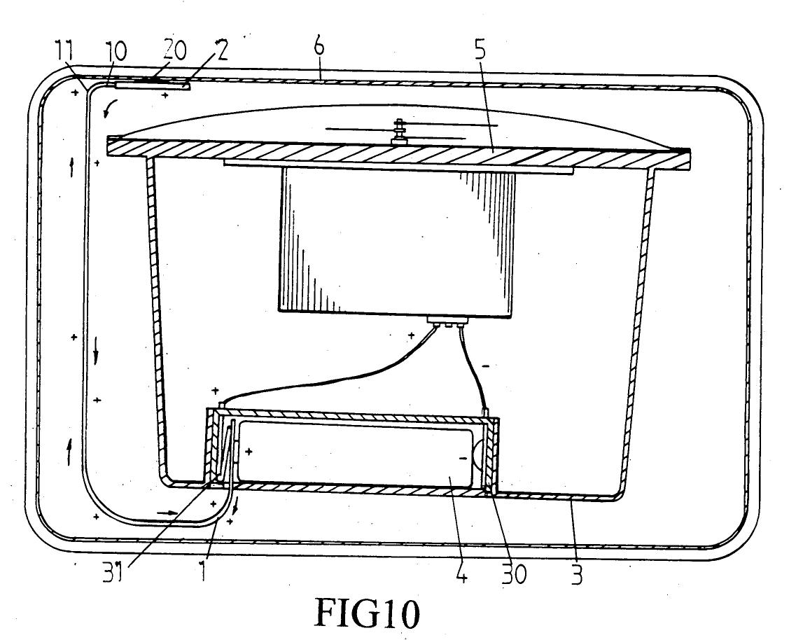

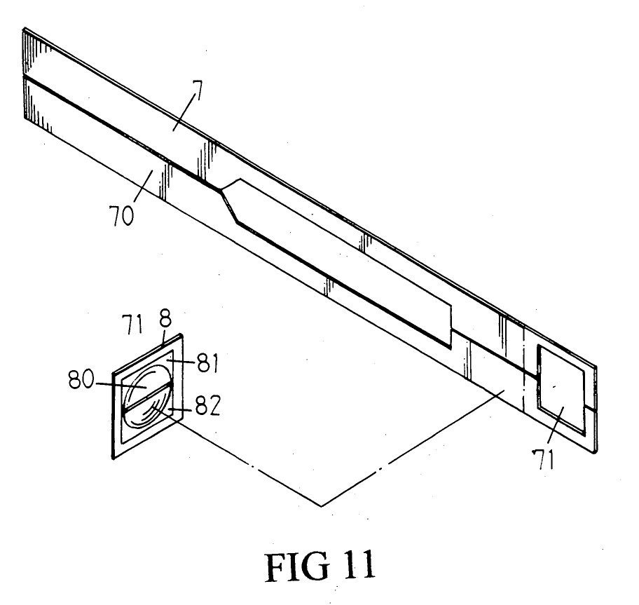

A consumer needs only to press said control switch installed on the packing box 6 (as shown in FIGS. 7 and 8), while pressing embossment 20, the electricity-conductive surface 200 will be pressed downward contacting against both electricity-conductive surfaces 10 and 11 located at the same side and hence creating an electricity-conductive path (as shown in FIG. 9), and in this way, hence the disconnected power for the battery originally will be supplied again to electrode 31 at the battery compartment 30 firstly via the control switch 2 in accordance with said spacer 1, and then energizing the clock movement 5 appropriately to go off the alarm bell directly (as shown in FIG. 10), and thus it is allowable for a purchaser to pre-listen the alarm bells as well as realize the operating status of such alarm clock by means of an easy and convenient way without opening its packing at all.

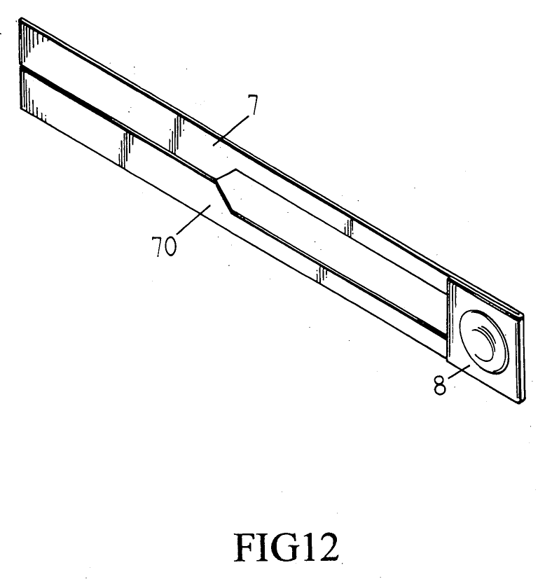

Again, with reference to both the FIGS. 11 and 12, they are illustrating the primary structure of said switch according to the present invention, comprising two spacers 7 and 70 and a control switch 8, in which t two spacers 7 and 70 are constructed as the lamella structure and further there is a slot 71 positioned at the front end, whereat said slot 71 has been folded partially in such a way that one electricity-conductive surface located in one side is being attached to another electricity-conductive surface located in other side, and hence make these two electricity-conductive surfaces position in the same side and, in addition, said two electricity-conductive surfaces will be in conjunction again with the control switch 8; where a press embossment 80 is constructed at the center portion of said control switch 8 having two separated (upper and lower) electricity-conductive surface 81 and 82, and in this way, it is applicable to accomplish the primary structure of said switch by controlling the operation method (in either contacting or detaching) for these two electricity-conductive surfaces at the same side while pressing said press embossment 80 accordingly (as shown in FIG. 12).

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A kind of switch for pre-listening the alarm bells of an alarm clock, comprising spacer and control switch, wherein the said spacer is constructed as a lamella structure with two electricity-conductive surfaces located at each side respectively, and there is a slot positioned at the front end, whereat said slot has been folded partially in such a way that one electricity-conductive surface located in one side is able to be attached to another electricity-conductive surface located in other side, and hence make these two electricity-conductive surfaces position in the same side and, in addition, the said two electricity-conductive surface is in conjunction again with the control switch; where a press embossment is constructed at the center portion of said control switch, and in this way, it is applicable to accomplish the primary structure of said switch by press controlling the operation method (in either contacting or detaching) for these two electricity-conductive surfaces positioned at the same side accordingly; primarily, the said spacer is inserted into the battery compartment of alarm clock at a position located in-between the electrode and the battery so as to separate the electrode from the battery, and thereat said control switch is extensible installed on the packing box, and more over, by the time while pressing the control switch on packing box directly, it will be applicable to control the contacting operation of electricity-conductive surfaces positioned at the same side and hence the disconnected power for the battery originally will be supplied again to electrode at the battery compartment firstly via the control switch according to said spacer, and then energizing the clock movement appropriately to go off the alarm bell directly, thus it is allowable for a purchaser to pre-listen the alarm bells as well as realize the operating status of such alarm clock by means of an easy and convenient way.
